(19) United States
(12) Patent Application Publication
(10) Pub. No.: US 2023/0254769 A1
(43) Pub. Date: Aug. 10, 2023

(54) METHOD AND APPARATUS FOR ADDITIONAL REFERENCE SIGNAL MONITORING

(71) Applicant: Lenovo (Beijing) Ltd., Beijing (CN)

(72) Inventors: Jie Shi, Haidian District (CN); Lianhai Wu, Chaoyang (CN); Jing Han, Chaoyang District (CN); Ran Yue, Chaoyang District (CN); Haiming Wang, Xicheng District (CN)

(73) Assignee: Lenovo (Beijing) Ltd., Beijing (CN)

(21) Appl. No.: 18/004,590

(22) PCT Filed: Jul. 10, 2020
(86) PCT No.: PCT/CN2020/101431

§ 371 Date: Jan. 6, 2023

(51) Int. Cl. H04W 52/02; H04W 68/00

(52) U.S. Cl. CPC H04W 52/0229; H04W 68/005

(57) ABSTRACT

Embodiments of the present disclosure relate to methods and apparatuses. According to some embodiments of the disclosure, a method may include: receiving, at a first base station from a second base station, assistant information related to user equipment (UE) grouping; and determining whether to transmit a reference signal (RS) associated with a paging message for a UE based on the assistant information.

### TECHNICAL FIELD

Embodiments of the present application generally relate to wireless communication technology, and more specifically relates to a method and apparatus for additional reference signal (RS) monitoring in a wireless communication system.

### BACKGROUND

In narrow band internet of things (NB-IoT) technology, a wake-up signal (WUS) mechanism is introduced for power saving in long term evolution (LTE) release 15 (R15), wherein a WUS indicates whether there is a paging process in a pre-defined paging occasion (PO).

Specifically, when the WUS mechanism is disabled, a UE always monitors paging messages on POs. When the WUS mechanism is enabled, the UE monitors the following possible paging messages in POs in response to the UE detecting a WUS, so that physical downlink control channel (PDCCH) blind detection can be performed. On the other hand, when the WUS mechanism is enabled, the UE will not monitor the following paging messages in POs in response to the UE not detecting any WUS.

In some other communication systems such as 3rd Generation Partnership Project (3GPP) 5G systems, which may also be referred to as new radio (NR) systems, an additional reference signal (RS), which is similar to the WUS, may be introduced for power saving. However, due to the differences between these systems (e.g., LTE systems and NR systems), techniques for applying the additional RS in, for example, NR systems, are desired.

### SUMMARY

One objective of the embodiments of the present application is to provide a solution of applying the RS associated with a paging message in wireless communication systems.

Some embodiments of the present disclosure provide a method. The method may include: receiving, at a first base station from a second base station, assistant information related to user equipment (UE) grouping; and determining whether to transmit a reference signal (RS) associated with a paging message for a UE based on the assistant information.

Some embodiments of the present disclosure provide a method. The method may include: transmitting, to a first base station at a second base station, assistant information related to user equipment (UE) grouping.

Some embodiments of the present disclosure provide a method. The method may include: receiving, from a first base station at a second base station, an indication of completion of data transmission between a user equipment (UE) and the first base station, wherein the second base station is the last serving station of the UE.

Some embodiments of the present disclosure provide a method. The method may include: receiving a path switch request message indicating a cell associated with a base station, wherein the cell is the serving cell of a user equipment (UE); and updating, in response to the reception of the path switch request message, a list of cells on which the UE monitors a reference signal (RS) associated with a paging message for the UE.

Some embodiments of the present disclosure provide a method. The method may include: receiving an indication of completion of data transmission between a user equipment (UE) and a first base station from a second base station, wherein the second base station is the last serving base station of the UE.

Some embodiments of the present disclosure provide a method. The method may include: monitoring, at a user equipment (UE), a reference signal (RS) associated with a paging message for the UE based on UE grouping configuration.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which advantages and features of the present application can be obtained, a description of the present application is rendered by reference to specific embodiments thereof which are illustrated in the appended figures. These figures depict only example embodiments of the present application and are not therefore to be considered as limiting of its scope.

FIG. 1 illustrates a schematic diagram of a wireless communication system in accordance with some embodiments of the present disclosure;

FIG. 2A illustrates a block diagram of mapping WUSs to POs in accordance with some embodiments of the present disclosure;

FIG. 2B illustrates a block diagram of mapping WUSs to POs in accordance with some embodiments of the present disclosure;

FIG. 3A illustrates a block diagram of mapping WUSs to POs in accordance with some embodiments of the present disclosure;

FIG. 3B illustrates a block diagram of mapping WUSs to POs in accordance with some embodiments of the present disclosure;

FIG. 4 illustrates a block diagram of exemplary WUS resource configuration in accordance with some embodiments of the present disclosure;

FIG. 5 illustrates an exemplary procedure for wireless communication in accordance with some embodiments of the present disclosure;

FIG. 6 illustrates an exemplary procedure for wireless communication in accordance with some embodiments of the present disclosure;

FIG. 7 illustrates an exemplary procedure for wireless communication in accordance with some embodiments of the present disclosure; and

FIG. 8 illustrates a block diagram of an apparatus in accordance with some embodiments of the present disclosure.

### DETAILED DESCRIPTION

The detailed description of the appended figures is intended as a description of the currently preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present disclosure, examples of which are illustrated in the accompanying drawings. To facilitate understanding, embodiments are provided under specific network architecture and new service scenarios, such as 3GPP 5G (NR), 3GPP LTE, and so on.

It is contemplated that along with the developments of network architectures and new service scenarios, all embodiments in the present disclosure are also applicable to similar technical problems; and moreover, the terminologies recited in the present disclosure may change, which should not affect the principle of the present disclosure.

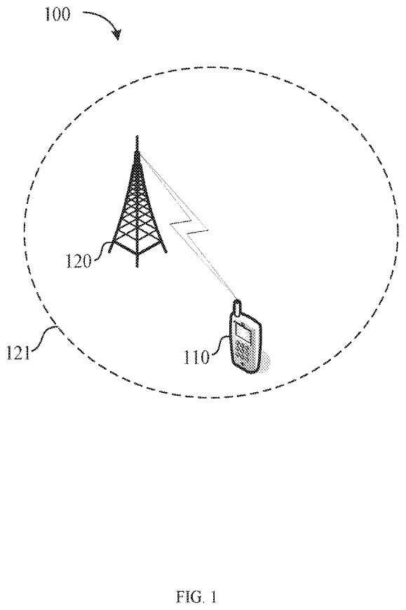

FIG. 1 illustrates a schematic diagram of a wireless communication system 100 in accordance with some embodiments of the present disclosure.

As shown in FIG. 1, the wireless communication system 100 may include one or more UEs (e.g., UE 110), one or more BSs (e.g., BS 120), and one or more radio access networks (RANs) (e.g., RAN 121). It is contemplated that the wireless communication system 100 may include any number of UEs, BSs, networks, and/or network components.

UE 110 may be any type of device configured to operate and/or communicate in a wireless environment. For example, UE 110 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 110 may include wearable devices, such as smart watches, fitness bands, optical head-mounted displays, or the like.

Moreover, UE 110 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs may communicate with a BS via uplink or downlink communication signals. Persons skilled in the art should understand that as technology develops and advances, the terminologies described in the present disclosure may change, but should not affect or limit the principle and spirit of the present disclosure.

BS 120 may be any type of device configured to wirelessly interface with at least one UE (e.g., UE 110) to facilitate access to one or more communication networks. BS 120 may operate, for example based on a standard protocol such as long-term evolution (LTE), LTE-advanced (LTE-A), new radio (NR), or other suitable protocol(s). In some embodiments of the present disclosure, the BS 120 may be referred to as an access point, an access terminal, a base, a base unit, a macro cell, a Node-B, an evolved Node B (eNB), a gNB, a Home Node-B, a relay node, or a device, or described using other terminology used in the art. Persons skilled in the art should understand that as the 3rd Generation Partnership Project (3GPP) and communication technology develop, the terminologies recited in the specification may change, which should not affect the principle of the disclosure.

BS 120 may transmit downlink (DL) communication signals to serve UEs (e.g., UE 110) in the time, frequency, and/or spatial domain. The DL communication signals may be carried over wireless communication links. The wireless communication links may be any suitable carrier in a licensed or unlicensed radio spectrum. The wireless communication links facilitate communication between the UEs and the BSs.

BS 120 may be part of RAN 121, which may also include other BSs and/or network elements (not shown), such as a base station controller (BSC), a radio network controller (RNC), and relay nodes. BS 120 may be configured to transmit and/or receive wireless signals within a particular geographic region, which may be referred to as a cell (not shown in FIG. 1). In some cases, the geographic region for a BS may be divided into sectors, each making up a portion of the geographic region. The term “cell” may refer to a portion of the geographic region (e.g., a sector). A BS may be associated with one or more cells.

RAN 121 may be in communication with a core network (not shown in FIG. 1). RAN 121 may employ one of various radio access technologies (RATs), such as evolved universal terrestrial radio access network (E-UTRAN) radio technology or NR radio technology. The core network (CN) may include a plurality of CN components, such as a mobility management entity (MME) (not shown in FIG. 1) or an access and mobility management function (AMF) (not shown in FIG. 1). The CNs may serve as a gateway for the UEs to access a public switched telephone network (PSTN) and/or other networks (not shown in FIG. 1).

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 120 may transmit data using an OFDM modulation scheme on the DL and UE 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols. The present application is not intended to be limited to the implementation of any particular wireless communication system architecture or protocol.

According to some embodiments of the present application, a WUS mechanism may be used for power saving in monitoring paging messages in POs. For example, in response to accessing a wireless communication network, the UE may read wireless communication system information to identify an enabled or disabled status of a WUS mechanism. In response to the WUS mechanism being disabled, the UE may always monitor possible paging messages in POs computed by a paging formulation. Otherwise, in response to the WUS mechanism being enabled, the UE may detect a WUS prior to a PO in time domain, and then monitor a paging message in the PO based on the detected WUS.

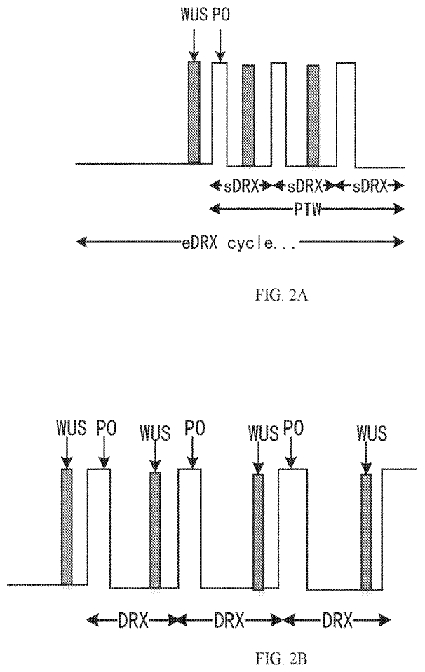

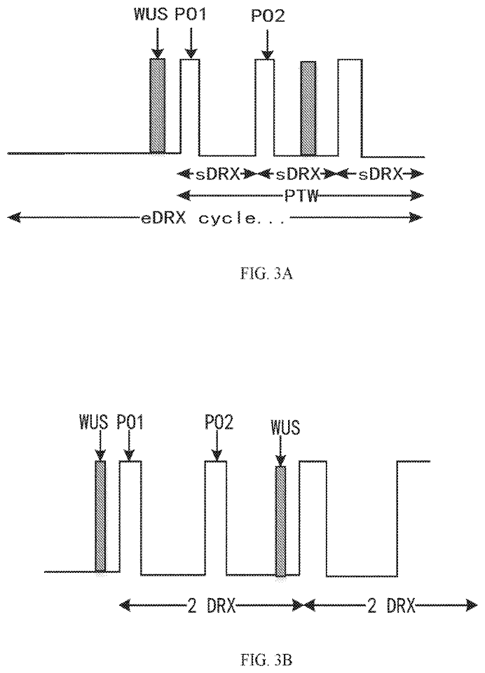

POs may be POs in a discontinuous reception (DRX) mode/extended DRX (eDRX) mode, or may be dedicated POs distributed in the DRX mode/eDRX mode. In one eDRX cycle of the eDRX mode, one paging transmission window (PTW) may include one or more POs. There may be multiple short DRXs (sDRXs) in one PTW. In response to one PTW including multiple sDRXs, the number of the POs may be countered based on an sDRX cycle. Moreover, according to LTE R15, the relation of the WUS to the PO can be 1-to-N, and N can be 1, 2, or 4. That is, one WUS can be mapped to one PO as shown in FIGS. 2A and 2B, or mapped to multiple POs as shown in FIGS. 3A and 3B.

Specifically, FIG. 2A illustrates a block diagram of mapping WUSs to POs in accordance with some embodiments of the present disclosure, wherein one WUS is mapped to one PO in an eDRX mode.

As shown in FIG. 2A, in one eDRX cycle of the eDRX mode, there are three sDRXs in one PTW, and each WUS is applied to each PO in one sDRX of the PTW. Persons skilled in the art well know that one PTW of the eDRX mode may include different numbers of sDRXs or POs. Thus, the number of sDRXs or POs and the number of WUSs mapped to POs may be different from this embodiment of the present application.

FIG. 2B illustrates a block diagram of mapping WUSs to POs in accordance with some embodiments of the present disclosure, wherein one WUS is mapped to one PO in a DRX mode. As shown in FIG. 2B, each WUS is applied to each PO in one DRX cycle in the DRX mode.

FIG. 3A illustrates a block diagram of mapping WUSs to POs in accordance with some embodiments of the present disclosure, wherein one WUS is mapped to multiple POs in an eDRX mode.

As shown in FIG. 3A, in one eDRX cycle of the eDRX mode, there are three sDRXs in one PTW. Each sDRX includes one PO, and one WUS may be applied to two POs, i.e., PO1 and PO2 in one PTW of the eDRX mode. In some other embodiments of the present application, one WUS may be applied to all POs in one PTW. In addition, persons skilled in the art well know that one PTW of the eDRX mode may include different numbers of sDRXs or POs. Thus, the number of sDRXs or POs and the number of WUSs applied to POs may be various in different embodiments of the present application.

FIG. 3B illustrates a block diagram of mapping WUSs to POs in accordance with some embodiments of the present disclosure, wherein one WUS may be mapped to multiple POs in a DRX mode. As shown in FIG. 3B, one WUS is applied to two POs in two DRX cycles (denoted as “2 DRX” in FIG. 3B). Persons skilled in the art well know that, in some other embodiments of the present application, one WUS may be applied to more than two DRX cycles in a DRX mode, for example, one WUS may be applied to three or more POs in a DRX mode.

LTE R15 specifies that UEs paged in the same PO will be associated with the same WUS. For example, ten UEs paged in the same PO will detect the same WUS. In the case that a specific UE of the ten UEs will be paged by the network (e.g., a base station (BS)), the WUS for this specific UE will be sent to all of the ten UEs from the network side. That is, all of the ten UEs may receive this WUS for this specific UE. Accordingly, although no paging information for the other nine UEs will be received, the other nine UEs have to monitor the paging messages due to receiving a WUS. Clearly, the aim to save power when monitoring paging messages in POs cannot be achieved in this case, at least for the above-mentioned other nine UEs.

To reduce the probability of a false wake-up, a group wake-up signal (GWUS) is introduced to support grouping UEs in the WUS mechanism in 5G new radio release 16 (R16). Each UE group may correspond to a respective WUS sequence. Specifically, multiple UEs can be divided into different groups, and a specific WUS or WUS sequence is associated with a specific group of UEs and indicates the PO(s) associated with the specific group of UEs. The number of UE groups can be configured by the network (e.g., a BS or a CN entity). For example, the number of UE groups may be broadcast in a system information block (SIB). In some embodiments of the present application, the specific WUS sequence can also be associated with one or more groups of UEs.

During a paging process, only UE(s) within the specific group may monitor a paging message in the PO(s) based on the detected specific WUS, while other UEs not included in this specific group may not monitor the paging message in the PO(s) based on the specific WUS. Accordingly, during the paging process, UEs can save more power in a WUS mechanism applying the GWUS scheme than when using the legacy R15 WUS scheme.

Moreover, there may be several grouping rules, including, but not limited to, a UE-ID based grouping rule, a paging probability based grouping rule, or a combination thereof. Under the UE-ID based grouping rule, a UE may determine its group index or group ID using a modulo operation, for example, (group ID)=F (UE ID) mod (the number of groups), wherein F (UE ID) represents a function associated with the UE ID.

Under the paging probability based grouping rule, UEs with the same or similar paging probabilities may be grouped in the same UE group. For example, UEs with the same paging probability (e.g., 30%) or having paging probabilities within the same paging probability threshold range (e.g., 0%-30%, 30%-60%, or 60%-100%) may be grouped in the same UE group, and thus have the same group index.

In some embodiments of the present application, both the UE-ID based grouping rule and the paging probability based grouping rule may be applied. For example, the paging probability information based grouping may include a further UE-ID based grouping. That is, a UE may firstly apply the paging probability based grouping rule to determine a paging probability group, and then the UE in a paging probability group may continue to apply the UE-ID based grouping rule to determine a UE group.

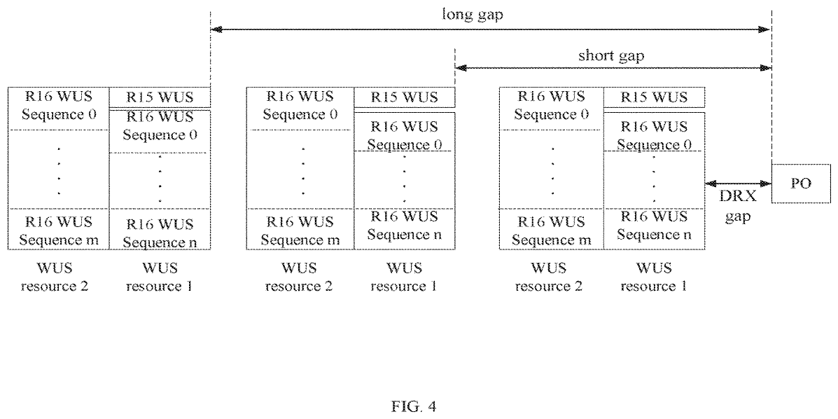

A UE may be configured with different DRX cycle types (e.g., long eDRX, short eDRX, and DRX). For the same PO, a UE can detect the corresponding WUS/GWUS by a DRX gap or eDRX gap. The eDRX gap may include a short gap corresponding to short eDRX or a long gap corresponding to the long eDRX as shown in FIG. 4. A BS may configure the WUS/GWUS resource and WUS/GWUS to different DRX cycles as shown in FIG. 4. The paging probability threshold information may be common to all UEs with different DRX cycle types. The GWUS allocation to each paging probability threshold or UE-ID based group is gap-specific.

FIG. 4 illustrates a block diagram of an exemplary WUS resource configuration according to some embodiments of the present application.

As shown in FIG. 4, for each gap (i.e., long gap for long eDRX, short gap for short eDRX, and DRX gap for DRX), two WUS resources may be configured. WUS resource 2 is a group of WUS sequences including WUS sequence 0 to WUS sequence m prior to WUS resource 1 in the time domain. WUS sequence 0 to WUS sequence m in WUS resource 2 may be code-multiplexed with each other. In some embodiments of the present application, there may be 16 WUS sequences code-multiplexed on a WUS resource. Each WUS sequence may be associated with at least one UE group.

WUS resource 1 includes an R15 WUS and a group of WUS sequences from WUS sequence 0 to WUS sequence n. In some embodiments of the present application, WUS sequence 0 to WUS sequence n in WUS resource 1 may be code-multiplexed with each other, and may be multiplexed with the R15 WUS in frequency domain. In some embodiments of the present application, the R15 WUS and WUS sequence 0 to WUS sequence n in WUS resource 1 may be code-multiplexed with each other. Each WUS sequence may be associated with at least one UE group.

In the following embodiments, the term “WUS” applied can mean either WUS or GWUS.

When configured in a cell, UEs, including but not limited to NB-IoT UEs, bandwidth reduced Low complexity (BL) UEs, and UEs in enhanced coverage, can use WUS to reduce power consumption related to paging monitoring. In some embodiments of the present application, a UE may monitor the WUS in every cell. In some embodiments of the present application, in order to avoid waking up other UEs due to, for example, the network (e.g., MME) paging a specific UE across multiple cells, the usage of WUS is restricted to the specific UE's last visited cell. The process may be implemented as follows.

For each WUS capable UE, a BS supporting WUS may provide the CN (e.g., MME) with a list of recommended cells for paging in, for example, a S1 application protocol (S1-AP) UE context release complete message or a S1-AP UE context suspend request message. When the CN (e.g., MME) receives the list of recommended cells for a specific UE, it may include the latest list of recommended cells for the specific UE in a paging message (e.g., a S1-AP paging message). A BS may receive the list of recommended cells in the paging message, and may only indicate a WUS in the first cell of the list, e.g., the specific UE's last visited cell. Otherwise, if the BS does not receive such list, it may not indicate the WUS for the specific UE. A UE may monitor WUS only in its last visited cell, i.e., the cell where the UE was last released or suspended by a BS including the cell.

In NR systems, from the perspective of a network, a UE may be in one of the following states: RRC-IDLE state, RRC_CONNECTED state, and RRC_INACTIVE state, at a given time. Accordingly, a UE may be in an idle mode corresponding to the RRC_IDLE state, an inactive mode corresponding to the RRC_INACTIVE state, or a connected mode corresponding to the RRC_CONNECTED state. The specific characteristics of an RRC-IDLE state, RRC_CONNECTED state, and RRC_INACTIVE state are defined in 3GPP specifications.

In an RRC_IDLE state, there is no UE context for an idle UE in the RAN. Also, an idle UE has no connection via the BS with the CN (e.g., an AMF). When the CN wants to exchange data or signaling with an idle UE, the CN may trigger a paging procedure (e.g., S1 paging) for the idle UE.

In an RRC_INACTIVE state, an inactive UE does not have an RRC connection with the RAN. However, RRC_INACTIVE is a state where a UE remains in CM-CONNECTED and can move within an area configured by the RAN (e.g., NG RAN) without notifying the RAN. In other words, the transition from an RRC_CONNECTED state to an RRC_INACTIVE state is not notified to the CN. As a result, even when the UE is in the inactive mode, the CN may treat it as though it were in the connected mode—that is, the UE-associated signaling and user data connection between the CN and the RAN continues. When the last serving BS of an inactive UE (however, from the perspective of the CN, this BS is the currently serving BS of the UE) receives signaling or data for the inactive UE, it may trigger a paging procedure (e.g., RAN paging) for the inactive UE. The paging may be performed in a RAN-based Notification Area (RNA). The RNA may consist of one or more cells and may be configured to the UE when, for example, the UE was ordered to enter the inactive state. The inactive UE may need to perform an RNA update procedure when it moves out of the configured RNA. RNA and RAN paging make it possible for inactive UEs to move around in an area without notifying the network.

To improve power saving for an idle UE and inactive UE, a reference signal (RS) associated with UE paging (also referred to as “additional RS”) may be introduced. The additional RS may similar to the WUS signal in some aspects. The grouping rules may also be applied to the additional RS. Details described in all of the foregoing embodiments of the present disclosure with respect to the WUS are applicable for the additional RS. The WUS could be considered as one type of the additional RS.

However, the WUS mechanism does not consider certain scenarios such as the involvement of the inactive UEs or data transmission that may be initiated by an idle or inactive UE. For example, if a UE only monitors the WUS in its last visited cell as mentioned above, when an inactive UE has moved out of its last visited cell, the paging for this inactive UE may be extended to other cells. In this scenario, other UEs which share the same WUS as the inactive UE may be paged wrongly, which may lead to a wrong paging alarm to the other UEs. This extension could be a serious case when the inactive UE is paged in the whole tracking area (TA).

Embodiments of the present disclosure provide solutions for applying the RS in a wireless communication system such as an NR system. More details on the embodiments of the present disclosure will be illustrated in the following text in combination with the appended drawings.

For inactive UEs that can move around in a configured RNA, technical solutions for keeping a balance of minimizing UE power and wrong paging alarms are required. Considering that an inactive UE may move around in an RNA in a long period or between several cells in the RNA, expanding the cell that can indicate the additional RS for the inactive UE from the last used cell of the inactive UE to all or several cells in the same RNA may improve paging reachability in a short time. Although some wrong paging alarms may be generated in the RNA, it is not as serious as a TA level paging extension.

In some embodiments of the present disclosure, for an inactive UE, the cells that can apply the additional RS to an inactive UE may be expanded to all cells in the same RNA as the last used cell of the inactive UE. In other words, all cells in the same RNA as the last used cell of the inactive UE may indicate the additional RS for the inactive UE. In some embodiments of the present disclosure, for an inactive UE, the cells that can apply the additional RS to the inactive UE may be expanded to several particular cells in the same RNA as the last used cell of the inactive UE.

As mentioned above, an inactive UE may have a CN connection in a cell (e.g., cell A) associated with its last serving BS (also referred to as “anchor BS”). However, in some scenarios, the inactive UE may perform data transmission via another cell (cell B). The data transmission may include at least one of an uplink data transmission and downlink data transmission. For example, the inactive UE may initiate an uplink data transmission via cell B, establish a RAN connection with cell B, enter the connected mode, and then perform the data transmission. Or, the inactive UE may initiate an uplink data transmission via cell B and still stay in inactive mode in the data transmission procedure. An idle UE may act similarly.

After the completion of the data transmission, the inactive or idle UE may receive a suspend message or release message from cell B and then go back to the inactive or idle mode. Or, after the completion of the data transmission, the inactive or idle UE may receive a suspend message or release message from cell B and the UE still stay in inactive or idle mode in the data transmission procedure. In some embodiments of the present disclosure, the suspend message or release message is an RRC message. In some embodiments of the present disclosure, the data size in such data transmission may be no larger than the maximum transport block (TB) size that can be applied in one transmission, as defined in standard protocols. Small data transmission is one of such scenarios.

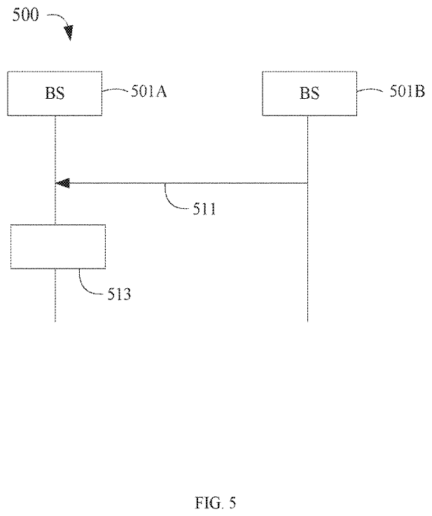

In the above scenarios, the last serving BS would know that cell B, instead of cell A, is the last used cell of the inactive UE. In the case that the last serving BS of an inactive UE receives signaling or data for the inactive UE, the last serving BS may trigger a paging procedure for the inactive UE. However, the inactive UE may not be paged in cell A. Therefore, cell B may apply the additional RS to the inactive UE. To achieve this, the last serving BS may transmit assistant information to its neighboring BSs, which will be explained in details below with respect to FIG. 5.

In some embodiments of the present disclosure, the term “last used cell” of a UE may refer to the cell where the UE was last released or suspended by a BS including or associated with the cell.

In some embodiments of the present disclosure, the term “last used cell” of a UE may refer to a cell where the UE has been most recently released or suspended to idle or inactive by a BS including or associated with the cell, while the ID of the cell is able to be transmitted to a CN (e.g., AMF or MME) to allow the CN to update the locally stored last used cell for the UE as the cell, and the CN is able to perform such updating.

For example, the release message or suspend message may include an indication that a core network (CN) has successfully updated the last used cell of the UE. Therefore, the UE would know that the cell can be considered as its last used cell. In some other examples, the release message or suspend message may include an indication that a core network (CN) has not updated the last used cell of the UE or an indication that the ID of the cell is not able to be transmitted to the CN to update the cell as the last used cell. Therefore, the UE would know that the cell cannot be considered as its last used cell. In some other examples, the last used cell of the UE is a last cell where the UE has received either a release message or a suspend message from a BS in connection with the CN. In yet other examples, the last used cell of the UE is a last cell where the UE has received either a release message or a suspend message from a BS, which is able to obtain an acknowledgement that the CN has successfully updated the last used cell of the UE. In some embodiments of the present disclosure, in the above procedures and other similar procedures, when the last used cell at the CN is not updated with the actual last used cell at the CN, the UE may consider the last used cell stored at the CN as its last used cell. The UE will detect the additional RS in the cell named as the last used cell at the CN.

For instance, a BS may release or suspend a UE in a specific cell of the BS. However, the release or suspension of the UE may not be successfully notified to the CN due to, for example, a disconnection or congestion between the BS and the CN. In this case, although the UE may receive a release or suspend message from the BS, the specific cell of the BS is not the last used cell of the UE. In another example, a BS may transmit a path switch request associated with a UE to the CN, and receive a path switch response indicating a successful path switch from the CN. After the BS transmits a release or suspend message to the UE to order it to enter an idle or inactive mode, the currently serving cell of the UE becomes the last used cell of the UE. In some embodiments of the present disclosure, in the above procedures and other similar procedures, when the last used cell at the CN is not updated with the actual last used cell , the UE may consider the last used cell stored at the CN as its last used cell. The UE will detect the additional RS in the cell named as the last used cell at the CN.

To put it another way, the UE may always consider the last used cell stored at the CN as its last used cell, which may be different or the same as the actually last used cell of the UE, as explained above.

In some other embodiments of the present disclosure, the suspend message may be replaced with a RRC early data complete message used in random access message 4 for a UE in an idle mode or inactive mode. In the scenario, the subject disclosure can still be applied to LTE systems or NR systems.

In some other embodiments of the present disclosure, in the above procedures and other similar procedures, when the last used cell at the CN is not updated with the actual last used cell, the UE may consider the actual last used cell (which is different from the last used cell stored at the CN) as its last used cell. The UE will detect the additional RS in the actual last used cell.

FIG. 5 illustrates an exemplary procedure 500 for wireless communication in accordance with some embodiments of the present disclosure. Details described in all of the foregoing embodiments of the present disclosure are applicable for the embodiments shown in FIG. 5.

In FIG. 5, BS 501A is within the same RNA as BS 501B. BS 501B and BS 501B may function as BS 120 in FIG. 1. For example, BS 501B and BS 501B may be an eNB or a gNB.

At the beginning, a UE may connect to a specific cell of BS 501B. At a later time, the UE may be ordered by BS 501B to enter an inactive state, and may be configured with an RNA. The inactive UE may move around in the RNA, and may move out of the specific cell of BS 501B. BS 501B may be recognized as the last serving BS of the inactive UE, and the specific cell (e.g., cell S) of BS 501B may be recognized as the last used cell of the inactive UE.

At a certain time, BS 501B may receive signaling or data for the inactive UE, and may trigger a RAN paging procedure for the inactive UE. For example, BS 501B may transmit an RS associated with an RAN paging message for the inactive UE in the last used cell of the inactive UE. However, the inactive UE may not be successfully paged because it has moved out of cell S. As a result, the paging for this inactive UE may be extended to other cells.

In some embodiments of the present disclosure, all cells in the same RNA as cell S may transmit RSs associated with the RAN paging message for the UE.

For example, in operation 511, BS 501B may transmit an RAN paging message for the UE to its neighboring BSs (e.g., BS 501A) which includes cells within the same RNA as cell S. The RAN paging message may be transmitted on an Xn interface. The RAN paging message may include assistant information related to UE grouping.

For example, the assistant information may include at least one of: paging probability information of the UE and an indication of whether UE grouping for paging is enabled or not at the UE. The assistant information may include the UE grouping information. The grouping information may be the grouping rule information of UEs. When the indication indicates that UE grouping is enabled, the UE may perform the UE-ID based grouping rule. When the indication indicates that UE grouping is disabled, the UE may not perform the UE-ID based grouping rule or any grouping rules. When the assistant information includes the paging probability information, the UE may perform the paging probability based grouping rule; otherwise, the UE may not perform the paging probability based grouping rule. Furthermore, the UE may perform the paging probability based grouping rule and UE-ID based grouping rule together based on the additional RS configuration. For example, one or more additional RS s having the same paging probability information or sharing other grouping parameter(s) may be associated with a UE group. Sharing grouping parameter means having the same grouping parameter. In this case, a UE in a UE group may perform the UE-ID based grouping. In some examples, one additional RS may be associated with a UE group or a plurality of UE groups. When the assistant information includes both the paging probability information and the indication, the UE may perform both the paging probability based grouping rule and the UE-ID based grouping rule.

In operation 513, BS 501A may determine to transmit an RS associated with the received paging message for the UE based on the assistant information. For example, BS 501A may determine an RS dedicated to the UE based on the assistant information, and transmit the RS in corresponding cell(s). The neighboring BSs may transmit the RAN paging message to its neighboring BSs such that all cells in the same RNA as cell S may transmit a corresponding RS associated with the RAN paging message.

From the perspective of the UE, it may monitor the RS(s) associated with a paging message in all cells within the same RNA as cell S. The UE may monitor the RS(s) based on UE grouping configuration (e.g., resource configuration and UE grouping rule). For other cells within a different RNA as cell S, the UE may monitor a paging message without an RS monitoring procedure. In other words, in these other cells, the UE may consider that an RS associated with a paging message would not be transmitted.

In some embodiments of the present disclosure, several particular cells in the same RNA as cell S may transmit the RSs associated with the RAN paging message for the UE.

For example, the assistant information may further indicate a list of cells on which the UE monitors the RS. The list of cells may include a number of most recently used cells of the UE, or a number of the most frequently used cells of the UE. In these embodiments, in operation 513, BS 501A may determine whether its cells are listed in the list of cells. When it is determined that at least one cell of BS 501A is listed in the list of cells, BS 501A may transmit an RS associated with the paging message for the UE in the at least one cell based on the assistant information. Otherwise, when it is determined that all cells of BS 501A are not listed in the list of cells, BS 501A will not transmit an RS associated with the paging message for the UE.

From the perspective of the UE, the number of the cells in the list may be predefined, for example, in standards; or the number of the cells in the list may be configured by the network (e.g., a BS or a CN entity such as MME or AMF). Assuming that the number of the cells is predefined or configured as N, the UE may record a list of cells including N most recently used cells or N most frequently used cells. In some examples, the number N may be equal to 1. The cells in the list of cells may be in the same RNA as cell S. When the UE is in an inactive mode, it may monitor an RS associated with a paging message in each cell in the list of cells. The UE may monitor the RS(s) based on UE grouping configuration (e.g., RS resource configuration and UE grouping rule). For other cells within a different RNA as cell S, or within the same RNA as cell S but not listed in the above list, the UE may monitor a paging message without an RS monitoring procedure. In other words, in these other cells, the UE may consider that an RS associated with a paging message would not be transmitted.

In the above embodiments, since all or several particular cells in the same RAN as the last used cell may transmit a corresponding RS to the UE, wrong paging alarm may be generated in some or all of these cells. In order to reduce the wrong paging alarm, the cells (e.g., cells of BS 501A) that are not the last used cell of the UE may transmit the corresponding RS(s) to the UE in an RS sequence (corresponding to an RS group) dedicated to mobile UEs. For example, RS sequences in an RS resource may be indexed from 0 to m, and an RS sequence indexed p (p is an integer within the range from 0 to m) may be assigned to mobile UEs. Cells of BS 501A may transmit an RS associated with a paging message to the mobile UE on RS sequence p. In this way, the RS to the mobile UE would not cause a wrong paging alarm to the UEs camped on the cells of BS 501A.

In some embodiments of the present disclosure, as mentioned above, after the BS 501B sends the UE into an inactive state, the inactive UE may initiate a data transmission with another BS (e.g., BS #C), which may send the UE back to the inactive mode after the completion of the data transmission or keep UE in the inactive mode during the data transmission. In these embodiments, cell S of BS 501B may no longer be the last used cell of the UE. Instead, the cell (e.g., cell C) of BS #C which performs the data transmission with the UE is the last used cell. Therefore, after BS 501B receives signaling or data for the UE, BS 501B may, in operation 511, transmit an RAN paging message for the UE to its neighboring BSs (e.g., BS 501A) which includes cells within the same RNA as cell S. The RAN paging message may be transmitted on an Xn interface. The RAN paging message may include assistant information related to the UE grouping. The assistant information may include at least one of: paging probability information of the UE and an indication of whether the UE grouping for paging is enabled or not at the UE. The assistant information may include the UE grouping information. The grouping information may be the grouping rule information of UEs. In some embodiments of the present disclosure, the assistant information may further indicate cell C. In some embodiments of the present disclosure, the assistant information may further indicate the most frequently used cell of the UE.

In operation 513, BS 501A may determine whether it includes cell C based on the assistant information. When it is determined that BS 501A includes cell C, BS 501A may transmit an RS associated with the paging message for the UE in cell C based on the assistant information. Otherwise, when it is determined that BS 501A does not include cell C, BS 501A will not transmit an RS associated with the paging message for the UE. BS 501A may transmit the RAN paging message to its neighboring BSs until it reaches the BS corresponding to the last used cell of the UE.

From the perspective of the UE, it may monitor an RS associated with a paging message in its last used cell. For other cells that are not the last used cell, the UE may monitor a paging message without an RS monitoring procedure. In other words, in these other cells, the UE may consider that an RS associated with a paging message would not be transmitted.

It should be appreciated by persons skilled in the art that the sequence of the operations in exemplary procedure 500 may be changed and some of the operations in exemplary procedure 500 may be eliminated or modified, without departing from the spirit and scope of the disclosure.

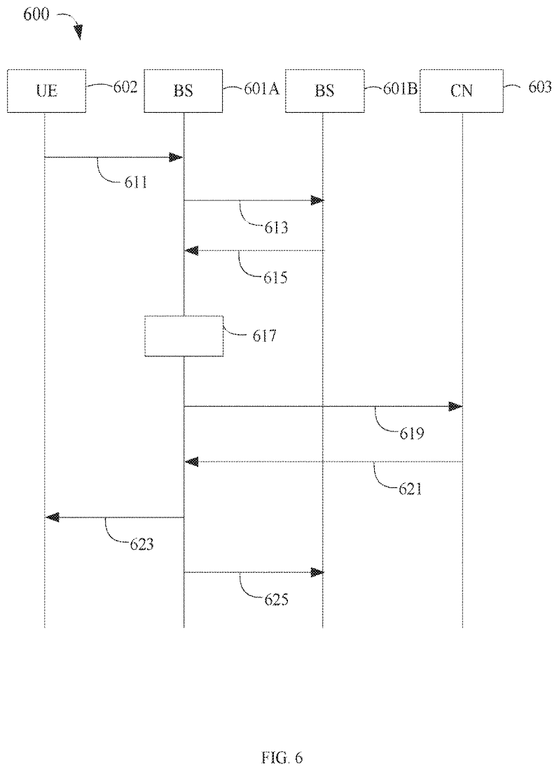

FIG. 6 illustrates an exemplary procedure 600 for wireless communication in accordance with some embodiments of the present disclosure. Details described in all of the foregoing embodiments of the present disclosure are applicable for the embodiments shown in FIG. 6.

Referring to FIG. 6, UE 602 may function as UE 110 in FIG. 1, and BS 601A and BS 601B may function as BS 120 in FIG. 1. For example, BS 601B and BS 601B may be an eNB or a gNB.

At the beginning, UE 602 may communicate with a BS (e.g., BS 601B). UE 602 may perform an RNA update procedure when it moves out of BS 601B (i.e., the lasting serving BS), and may switch to a new base station (e.g., BS 601A). At this time, BS 601A is the serving BS of UE 602 and the cell (e.g., cell D) of BS 601A where UE 602 is located is the serving cell of UE 602. After the completion of the RNA update procedure, BS 601A may set UE 602 to inactive, and cell D of BS 601A may become the last used cell of UE 602. In this case, the list of recommended cells for paging should be updated at the CN (e.g., AMF or MME). Otherwise, the cell UE 602 considers as the last used cell would be different from the one the CN recognizes as the last used cell of UE 602, and UE 602 might miss the paging. Details will be explained below.

In operation 611, UE 602 may transmit an RRC connection resume request to BS 601A. In some embodiments, the resume request may include the identity of UE 602. The identity of UE 602 may be a resume ID configured by the last serving base station (e.g., 601B) in an RRC release message. The resume ID may include information regarding the last serving base station (e.g., BS 601B). In some embodiments, a resume ID may include an Inactive-Radio Network Temporary Identifier (I-RNTI).

In operation 613, BS 601A may transmit a request for acquiring the UE context of UE 602 to the lasting serving base station (e.g., BS 601B) of UE 602. In some embodiments, the request for acquiring the UE context may include the identity of UE 602. In operation 615, BS 601B may transmit a retrieve UE context response message to BS 601A. The retrieve UE context response message may include assistant information related to the UE grouping of UE 602, and may be transmitted via an Xn interface.

For example, the assistant information may include at least one of: paging probability information of UE 602 and an indication of whether UE grouping for paging is enabled or not at UE 602. The assistant information may include the UE grouping information. The grouping information may be the grouping rule information of UEs. When the indication indicates that UE grouping is enabled, UE 602 may perform the UE-ID based grouping rule. When the indication indicates that UE grouping is disabled, UE 602 may not perform the UE-ID based grouping rule or any grouping rules. When the assistant information includes the paging probability information, UE 602 may perform the paging probability based grouping rule; otherwise, UE 602 may not perform the paging probability based grouping rule. Furthermore, the UE may perform the paging probability based grouping rule and UE-ID based grouping rule together based on the additional RS configuration. For example, one or more additional RS having the same paging probability information or sharing other grouping parameter(s) may be configured to belong to a UE group. Sharing grouping parameter means having the same grouping parameter. In this case, a UE in a UE group may perform the UE-ID based grouping. When the assistant information includes both the paging probability information and the indication, UE 602 may perform both the paging probability based grouping rule and the UE-ID based grouping rule.

In operation 617, BS 601A may determine to set UE 602 to inactive or IDLE. In operation 619, BS 601A may transmit a path switch request for UE 602 to CN 603 (e.g., AMF or MME). The path switch request may indicate the serving cell (e.g., cell D) of UE 602. In some examples, the path switch request may include user location information which indicates the cell D.

In response to the path switch request, CN 603 may update a list of cells (e.g., the list of recommended cells) on which UE 602 monitors a RS associated with a paging message for UE 602. For example, CN 603 may use cell D as the first cell indicated in the list of cells.

In some embodiments of the present disclosure, in operation 621, CN 603 may transmit a path switch request response to BS 601A. In operation 623, BS 601A may transmit a release message or suspend message to UE 602. The release message or a suspend message may indicate that at CN 603, the last used cell of UE 602 has been updated with the serving cell (e.g., cell D) of the UE. For example, CN 603 has updated the first cell in the list of recommended cells for paging UE 602 as cell D. In operation 625, BS 601A may transmit a UE context release message to BS 601B.

In some other embodiments of the present disclosure, the list of cells may not be successfully updated at CN 603. In this case, in operation 621, CN 603 may transmit a path switch request failure message to BS 601A. In operation 623, BS 601A may transmit a release message or suspend message to UE 602. The release message or a suspend message may indicate that at CN 603, the last used cell of UE 602 has not been updated with the serving cell (e.g., cell D) of the UE.

From the perspective of UE 602, it may monitor an RS associated with a paging message in its last used cell (e.g., cell D). By updating the list of recommended cells for paging UE 602 at the CN, when the CN wants to page a UE, the CN may initiate a paging message (e.g., Si paging message) to a corresponding BS including the last used cell of UE 602, which may transmit an RS associated with a subsequent RAN paging message (corresponding to the Si paging message) for the UE.

It should be appreciated by persons skilled in the art that the sequence of the operations in exemplary procedure 600 may be changed and some of the operations in exemplary procedure 600 may be eliminated or modified, without departing from the spirit and scope of the disclosure.

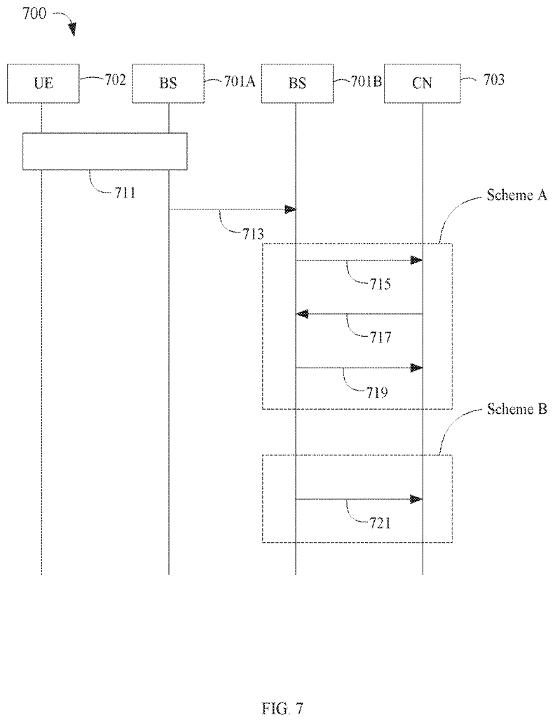

FIG. 7 illustrates an exemplary procedure 700 for wireless communication in accordance with some embodiments of the present disclosure. Details described in all of the foregoing embodiments of the present disclosure are applicable for the embodiments shown in FIG. 7.

Referring to FIG. 7, UE 702 may function as UE 110 in FIG. 1, and BS 701A and BS 701B may function as BS 120 in FIG. 1. For example, BS 701B and BS 701B may be an eNB or a gNB.

At the beginning, UE 702 may communicate with BS 701B (e.g., in cell E), which is connected to CN 703 (e.g., AMF or MME). BS 701B may send UE 702 to inactive or idle. BS 701B may be referred to as the last serving BS of UE 702. In operation 711, UE 702 may initiate a data transmission with BS 701A (e.g., in cell F). The data transmission may include a small data transmission. In some examples, UE 702 may establish a RAN connection with BS 701A, enter the connected mode, and then perform the data transmission. After completion of the data transmission, UE 702 may receive a release or suspend message from BS 701A and may enter an idle or inactive mode. In some other examples, UE 702 may establish a RAN connection with BS 701A, and then perform the data transmission in an inactive mode. After completion of the data transmission, UE 702 may receive a release or suspend message from BS 701A and may enter an idle or inactive mode. At this time, cell F, instead of cell E, is supposed to be the last used cell of UE 702. UE 702 is supposed to monitor an RS associated with a paging message (if configured) and the paging message in cell F.

However, the CN (e.g., CN 703) may only recognize cell E as the last used cell of UE 702, and may not be aware of BS 701A as well as the actual last used cell of UE 702, i.e., cell F. Accordingly, the list of recommend cells at the CN may not be updated. BS 701A may not transmit the RS associated with a paging message for UE 702 in cell F because cell F is not included in the list of recommend cells received via an Xn interface. As a result, UE 702 may miss the paging message since the associated RS is not detected. To resolve this issue, the CN should be informed of the update of the last used cell of UE 702.

For example, referring to FIG. 7, in operation 713, BS 701A may transmit an indication of completion of the data transmission between UE 702 and BS 701A to BS 701B. The data transmission may include at least one of an uplink data transmission or downlink data transmission.

The indication of completion of the data transmission may indicate at least one of the following:
(1) an end indication of the data transmission;
(2) that UE 702 has received a release message or a suspend message from BS 701A;
(3) that UE 702 has successfully received the release message or the suspend message from BS 701A;
(4) that BS 701A has transmitted the release message or the suspend message;
(5) that BS 701A has successfully transmitted the release message or the suspend message;
(6) an end indication for a quality of service (QoS) flow via a data radio bearer (DRB) associated with the data transmission, wherein the DRB may be an uplink DRB or downlink DRB;
(7) a service data adaptation protocol (SDAP) end marker for the QoS flow via the corresponding DRB;
(8) an end marker for one or more DRB;
(9) an end marker for one or more signaling radio bearer (SRB); and
(10) an end marker for one or more SRB and DRB.

There are two schemes (i.e., scheme A and scheme B as shown in FIG. 7) for informing the last used cell of UE 702 to CN 703.

In scheme A, in operation 715, BS 701B may transmit the indication of completion of data transmission between UE 702 and BS 701A to CN 703. In operation 717, CN 703 may transmit a request for retrieving the context of UE 702 to BS 701B. In operation 719, BS 701B may transmit a response message in response to the retrieve UE context request. The response message may indicate the cell (e.g., cell F) in which UE 702 completes the data transmission. In response to receiving the response message, CN 703 may update a list of cells (e.g., the list of recommended cells) on which UE 702 monitors an RS associated with a paging message for UE 702. For example, CN 703 may use cell F as the first cell indicated in the list of cells.

In scheme B, in operation 721, BS 701B may transmit a UE context update message to CN 703, in response to the indication of completion of data transmission. The UE context update message may indicate the cell (e.g., cell F) in which UE 702 completes the data transmission. In response to receiving the UE context update message, CN 703 may update a list of cells (e.g., the list of recommended cells) on which UE 702 monitors an RS associated with a paging message for UE 702. For example, CN 703 may use cell F as the first cell indicated in the list of cells.

In some examples, in response to receiving data or signaling for UE 702, BS 701A may transmit an RS associated with a subsequent RAN paging message for UE 702 only in cell F. In some examples, CN 703 may transmit a paging message for UE 702 based on the updated list of cells. For instance, the paging message may include the ID of cell F such that BS 701A transmit an RS associated with the paging message for UE 702 only in cell F.

From the perspective of UE 702, it may monitor an RS associated with a paging message in its last used cell (e.g., cell F), and may monitor a paging message without an RS monitoring procedure in cells that are not the last used cell. In some embodiments of the present disclosure, UE 702 may monitor an RS in a cell where UE 702 has performed a release procedure or a suspend procedure in response to the reception of a physical layer (PHY) acknowledgment (ACK) corresponding to the data transmission. Reception of a PHY ACK corresponding to a data transmission may be consider as a UE having received the release message or suspend message.

In some embodiments of the present disclosure, UE 702 may monitor an RS in the last used cell of the UE. In some examples, the last used cell of the UE is a last cell where the UE has received either a release message or suspend message, and the ID of the cell is able to be transmitted to a core network (CN) to update the cell as the last used cell.

In some examples, the last used cell of the UE is a last cell where the UE has received either a release message or suspend message, which indicates that the ID of the cell is able to be transmitted to a core network (CN) to update the cell as the last used cell, or indicates that the last used cell of the UE has been updated with the serving cell of the UE at the core network entity. The last used cell being updated with the serving cell of the UE at the core network entity means that the last used cell of the UE at the core network entity is updated by the serving cell of the UE.

In some examples, the last used cell of the UE is not a last cell where the UE has received either a release message or a suspend message, which indicates that the ID of the cell is not able to be transmitted to a core network (CN) to update the cell as the last used cell, or indicates that the last used cell of the UE has not been updated with the serving cell of the UE at the core network entity. The last used cell of the UE not being updated with the serving cell of the UE at the core network entity means that the last used cell of the UE at the core network entity is not updated by the serving cell of UE.

The release message or suspend message in this disclosure can also be applied to an LTE network. For example, an idle mode UE in an LTE network may receive the release message or suspend message from a BS (e.g., eNB). The idle mode UE in an NR network may receive the release message or suspend message from a BS (e.g., gNB). The inactive mode UE in an NR network may receive the release message or suspend message from its serving BS (e.g., gNB).

It should be appreciated by persons skilled in the art that the sequence of the operations in exemplary procedure 700 may be changed and some of the operations in exemplary procedure 700 may be eliminated or modified, without departing from the spirit and scope of the disclosure.

In the above text, a paging message may be a message with PDCCH-enhanced paging, where a UE could be grouped in the paging message. There may be several ways to indicate the UE grouping information, for example, by different paging radio network temporary identities (P-RNTIs) for different groups, by different control resource sets (CORESETs)/search spaces of paging DCIs for different groups, or by indicators in paging DCI indicating group information explicitly. So, a reference signal (RS) associated with a paging message could be for a UE or for a UE group. A UE may be considered as a UE group or the UE in a group in the present disclosure.

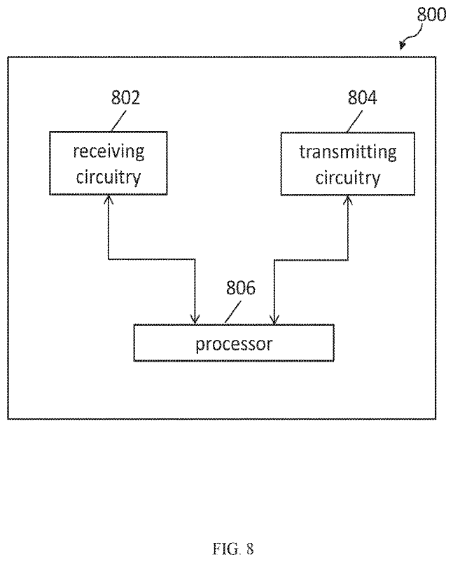

FIG. 8 illustrates an example block diagram of an apparatus 800 according to some embodiments of the present disclosure. In some embodiments of the present application, the apparatus 800 may be a BS as illustrated in above embodiments of the present application. In some embodiments of the present application, the apparatus 800 may be a CN entity (e.g., AMF or MME) as illustrated in the above embodiments of the present application. In some embodiments of the present application, the apparatus 800 may be a UE as illustrated in the above embodiments of the present application.

Referring to FIG. 8, the apparatus 800 may include at least one non-transitory computer-readable medium 802, at least one receiving circuitry 804, at least one transmitting circuitry 806, and at least one processor 808. In some embodiments of the present application, at least one receiving circuitry 804 and at least one transmitting circuitry 806 can be integrated into at least one transceiver. The at least one processor 808 may be coupled to the at least one non-transitory computer-readable medium 802, the at least one receiving circuitry 804 and the at least one transmitting circuitry 806. In some embodiments of the present disclosure, the apparatus 800 may further include an input device, a memory, and/or other components.

In some embodiments of the present disclosure, the at least one non-transitory computer-readable medium 802 may have stored thereon computer-executable instructions to cause the at least one processor 808 to implement the operations, steps, or methods with respect to the UEs as described above. For example, the computer-executable instructions, when executed, cause the at least one processor 808 interacting with the at least one receiving circuitry 804 and the at least one transmitting circuitry 806, so as to perform the steps with respect to the UEs described in FIGS. 1-7. In some examples, the at least one processor 808 may monitor an RS associated with a paging message based on a UE grouping configuration. The at least one receiving circuitry 804 may receive the RS based on the UE grouping configuration, and may receive a subsequent paging message.

In some embodiments of the present disclosure, the at least one non-transitory computer-readable medium 802 may have stored thereon computer-executable instructions to cause the at least one processor 808 to implement the operations, steps, or methods with respect to the BSs as described above. For example, the computer-executable instructions, when executed, cause the at least one processor 808 interacting with the at least one receiving circuitry 804 and the at least one transmitting circuitry 806, so as to perform the steps with respect to the BSs depicted in FIGS. 1-7.

In some examples, the at least one receiving circuitry 804 may receive assistant information related to a UE grouping from a BS. The at least one processor 808 may determine whether to transmit an RS associated with a paging message for a UE based on the assistant information. In some examples, the at least one transmitting circuitry 806 may transmit assistant information related to a user equipment (UE) grouping to a BS. In some examples, the at least one receiving circuitry 804 may receive an indication of completion of data transmission between a UE and a base station.

In some embodiments of the present disclosure, the at least one non-transitory computer-readable medium 802 may have stored thereon computer-executable instructions to cause the at least one processor 808 to implement the operations, steps, or methods with respect to the CN entity as described above. For example, the computer-executable instructions, when executed, cause the at least one processor 808 interacting with the at least one receiving circuitry 804 and the at least one transmitting circuitry 806, so as to perform the steps with respect to the BSs described in FIGS. 1-7.

In some examples, the at least one receiving circuitry 804 may receive a path switch request message. The path switch request message may indicate a cell associated with a base station, wherein the cell is the serving cell of a UE. In response to the path switch request message, the at least one processor 808 may update a list of cells on which the UE monitors an RS associated with a paging message for the UE. In some examples, the at least one receiving circuitry 804 may receive an indication of completion of data transmission between a UE and a base station from another base station, wherein the another base station is the last serving base station of the UE.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including.”

1-46. (canceled)

47. A method, comprising:
monitoring, at a user equipment (UE), a reference signal (RS) associated with a paging message for the UE based on UE grouping configuration.

48. The method of claim 47, wherein when the UE is in an inactive mode, the UE monitors the RS in all cells within a same radio access network based Notification Area (RNA).

49. The method of claim 47, wherein when the UE is in an inactive mode, the UE monitors the RS in a number of cells within a same radio access network based Notification Area (RNA) as a last used cell of the UE.

50. (canceled)

51. (Canceled)

52. The method of claim 47, wherein the UE monitors the RS in a last used cell of the UE or a most frequently used cell of the UE.

53. The method of claim 48, wherein a last used cell of the UE is a last cell where the UE has received either a release message or a suspend message.

54. (canceled)

55. (canceled)

56. The method of claim 48, wherein a last used cell of the UE is not a last cell where the UE has received either a release message or a suspend message, which indicates that an ID of the cell is not able to be transmitted to a core network (CN) to update the cell as the last used cell, or indicates that the last used cell of the UE has not been updated with a serving cell of the UE at the core network.

57. (canceled)

58. An apparatus, comprising:
a receiving circuitry;
a transmitting circuitry; and
a processor coupled to the receiving circuitry and the transmitting circuitry configured to cause the apparatus to:
receive, at the apparatus from a second base station, assistant information related to user equipment (UE) grouping; and
determine whether to transmit a reference signal (RS) associated with a paging message for a UE based on the assistant information.

59. (canceled)

60. An apparatus, comprising:
a receiving circuitry;
a transmitting circuitry; and
a processor coupled to the receiving circuitry and the transmitting circuitry configured to cause the apparatus to:
monitor, at the apparatus, a reference signal (RS) associated with a paging message for the apparatus based on a user equipment (UE) grouping configuration, wherein the apparatus comprises a UE.

61. The method of claim 49, wherein the last used cell of the UE is a last cell where the UE has received either a release message or a suspend message.

62. The method of claim 49, wherein the last used cell of the UE is not a last cell where the UE has received either a release message or a suspend message, which indicates that an ID of the cell is not able to be transmitted to a core network (CN) to update the cell as the last used cell, or indicates that the last used cell of the UE has not been updated with a serving cell of the UE at the core network.

63. The method of claim 52, wherein the last used cell of the UE is a last cell where the UE has received either a release message or a suspend message.

64. The method of claim 52, wherein the last used cell of the UE is not a last cell where the UE has received either a release message or a suspend message, which indicates that an ID of the cell is not able to be transmitted to a core network (CN) to update the cell as the last used cell, or indicates that the last used cell of the UE has not been updated with a serving cell of the UE at the core network.

65. The apparatus of claim 60, wherein when the UE is in an inactive mode, the UE monitors the RS in a number of cells within a same radio access network based Notification Area (RNA) as a last used cell of the UE.

66. The apparatus of claim 65, wherein the last used cell of the UE is a last cell where the UE has received either a release message or a suspend message.

67. The apparatus of claim 65, wherein the last used cell of the UE is not a last cell where the UE has received either a release message or a suspend message, which indicates that an ID of the cell is not able to be transmitted to a core network (CN) to update the cell as the last used cell, or indicates that the last used cell of the UE has not been updated with a serving cell of the UE at the core network.

68. The apparatus of claim 60, wherein when the UE is in an inactive mode, the UE monitors the RS in all cells within a same radio access network based Notification Area (RNA).

69. The apparatus of claim 68, wherein a last used cell of the UE is a last cell where the UE has received either a release message or a suspend message.

70. The apparatus of claim 68, wherein a last used cell of the UE is not a last cell where the UE has received either a release message or a suspend message, which indicates that an ID of the cell is not able to be transmitted to a core network (CN) to update the cell as the last used cell, or indicates that the last used cell of the UE has not been updated with a serving cell of the UE at the core network.

71. The apparatus of claim 58, wherein the assistant information is received in a radio access network (RAN) paging message.

72. The apparatus of claim 71, wherein the assistant information comprises at least one of: paging probability information of the UE and an indication of whether UE grouping for paging is enabled or not at the UE.
